(19) United States
(12) Patent Application Publication
(10) Pub. No.: US 2003/0092795 A1
(43) Pub. Date: May 15, 2003

(54) Non-asbestos type friction material

(75) Inventors: Tatsufumi Miyaki, Oura-gun (JP); Mitsuru Kobayashi, Oura-gun (JP)

Correspondence Address: ARMSTRONG,WESTERMAN & HATTORI, LLP, 1725 K STREET, NW, SUITE 1000, WASHINGTON, DC, 20006, US

(73) Assignee: NISSHINBO INDUSTRIES, INC., Tokyo (JP)

(21) Appl. No.: 10/260,566

(22) Filed: Oct. 1, 2002

(30) Foreign Application Priority Data
Oct. 2, 2001 (JP) 2001-306149

(51) Int. Cl. C08J 5/14; C10M 101/00; F16D 1/00; F16C 1/00

(52) U.S. Cl. 523/155; 508/105

(57) ABSTRACT

This invention provides a non-asbestos friction material excellent not only in performance at the time of braking under high loading at high temperatures but also in performance at the time of braking under low loading at low temperatures even if lead sulfide is not used in the filler. In the non-asbestos type friction material comprising a non-asbestos fiber base material, a filler and a binder, the filler comprises spherical bronze powder and artificial graphite and is free of lead sulfide.

### BACKGROUND OF THE INVENTION

1. Field of the Invention

This invention relates to a useful non-asbestos type friction material for use in brake linings in automobiles, particularly in middle- to large-size commercial vehicles.

2. Description of the Related Art

Because of regulation of maximum loadage etc. the brake linings in automobiles particularly in middle- to large-size commercial vehicles have increasing demand for stability at the time of braking under low loading at low temperatures in addition to conventional performance at the time of braking under high loading at high temperatures. As a measure therefor, a friction material wherein lead sulfide regarded as insoluble and nontoxic is used in a filler has been developed and practically used as disclosed in e.g. Japanese Patent Application Publication (JP-B) 8-26303.

However, a law (PRTR law) regarding promotion of improvement of control such as control of exhaust of specified chemical substances into the environment has been recently enforced, and lead sulfide also came to be the subject of the law as “lead and its compound”. Lead sulfide is scattered as abraded powder particularly at the time of braking, to cause burden on the environment, and thus its limitation came to be regarded as a problem. However, the friction material when deprived of lead sulfide becomes inferior in stability at the time of braking under low loading at low temperatures, to easily cause the problem of brake pull i.e. difference between right and left wheels in terms of brake force. That is, the conventional friction material when deprived of lead sulfide becomes inferior in the stability of brake force at the time of braking, thus causing a difference in brake force and abrasion between the two wheels, and particularly, brake pull occurs frequently at an initial stage of braking.

### SUMMARY OF THE INVENTION

In light of the prior art described above, the object of this invention is to provide a non-asbestos type friction material excellent not only in performance at the time of braking under high loading at high temperatures, but also in performance at the time of braking under low loading at low temperatures even if lead sulfide is not used in the filler.

The invention made for solving the problem lies in a non-asbestos type friction material comprising a non-asbestos fiber base material, a filler and a binder, wherein the filler comprises spherical bronze powder and artificial graphite and is free of lead sulfide.

Accordingly, the filler used is the one free of lead sulfide and comprising artificial graphite as a lubricant for regulating friction and spherical bronze powder as metal powder, and it is desired that the content of the spherical bronze powder is 0.1 to 3% by volume relative to the total amount the friction material, and the content of the artificial graphite is 0.5 to 5% by volume relative to the total amount the friction material. The reason for this limitation to the amount of spherical bronze powder and artificial graphite relative to the total amount of the friction material is that no lubricating effect occurs in an amount less than the lower limit, while inconveniences to balance in friction performance, such as a reduction in frictional coefficient, etc., occur in an amount higher than the upper limit.

That is, the present inventors made extensive study for solving the problem described above, and as a result, they found that a non-asbestos type friction material excellent not only in performance at the time of braking under high loading at high temperatures but also in performance at the time of braking under low loading at low temperatures can be obtained without using lead sulfide by incorporating, into a filler, artificial graphite—for example, milled electrode graphite (average particle diameter 150 to 250 μm)—as a lubricant for regulating friction and spherical bronze powder (average particle diameter 63 to 125 μm) as metal powder in place of lead sulfide, and this invention has thereby been completed.

### DESCRIPTION OF THE PREFERRED EMBODIMENTS

The non-asbestos fiber base material used in this invention includes organic fibers such as aramid fibers, inorganic fibers such as glass fibers, rock wool and potassium titanate fibers, and metal fibers such as copper, bronze, aluminum and brass. The filler includes organic fillers such as cashew dust and tire-rubber powder, and inorganic fillers such as molybdenum disulfide, calcium hydroxide, calcium carbonate, barium sulfate, zirconium silicate, magnesium oxide, copper powder and aluminum powder, and the binder includes phenol resin, epoxy resin and various kinds of rubber modified phenol resin.

Hereinafter, this invention is described by reference to the Examples.

In the Examples of this invention, aramid fibers and glass fibers were used as the fiber base material; phenol resin as the binder; cashew dust and rubber powder as the organic filler; and barium sulfate, calcium carbonate, zirconium silicate, milled electrode graphite and spherical bronze powder as the inorganic filler, and these materials were uniformly mixed in suitable amounts to give 6 friction materials, while in Comparative Examples, 3 friction materials were produced by using the same materials as in the Examples above except that the spherical bronze powder and milled electrode graphite were not used, and instead, lead sulfide was used or not used, and the resulting mixtures were preliminarily molded at a temperature of 333K to 383K and at a pressure of 5 to 20 MPa, and then heated and pressurized at a temperature of 414K to 473K and at a pressure of 10 to 20 MPa, and thereafter, the molded products were subjected in a usual manner to grinding and finishing, whereby the friction materials in Examples a to f and the friction materials in Comparative Examples A to C shown in Table 1 were obtained.

TABLE 1

| | | | | | | | Comparative | | |
|---|---|---|---|---|---|---|---|---|---|
| | Examples | | | | | | Examples | | |
| Raw materials | a | b | c | d | e | f | A | B | C |
| Phenol resin | 21.0 | 21.0 | 21.0 | 21.0 | 21.0 | 21.0 | 21.0 | 21.0 | 21.0 |
| Aramid fiber | 6.0 | 6.0 | 6.0 | 6.0 | 6.0 | 6.0 | 6.0 | 6.0 | 6.0 |
| Glass fiber | 7.0 | 7.0 | 7.0 | 7.0 | 7.0 | 7.0 | 7.0 | 7.0 | 7.0 |
| Cashew dust | 16.0 | 16.0 | 16.0 | 16.0 | 16.0 | 16.0 | 16.0 | 16.0 | 16.0 |
| Rubber | 10.0 | 10.0 | 10.0 | 10.0 | 10.0 | 10.0 | 10.0 | 10.0 | 10.0 |
| Aluminum articles | 4.0 | 4.0 | 4.0 | 4.0 | 4.0 | 4.0 | 4.0 | 4.0 | 4.0 |
| Lead sulfide | 0.0 | 0.0 | 0.0 | 0.0 | 0.0 | 0.0 | 0.0 | 1.0 | 2.0 |
| Barium sulfate | 27.9 | 26.7 | 24.4 | 23.0 | 23.0 | 21.0 | 29.0 | 28.0 | 27.0 |
| Calcium carbonate | 5.0 | 5.0 | 5.0 | 5.0 | 5.0 | 5.0 | 5.0 | 5.0 | 5.0 |
| Zirconium silicate | 2.0 | 2.0 | 2.0 | 2.0 | 2.0 | 2.0 | 2.0 | 2.0 | 2.0 |
| Spherical bronze powder | 0.1 | 0.3 | 0.6 | 1.0 | 2.0 | 3.0 | 0.0 | 0.0 | 0.0 |
| Milled electrode graphite | 1.0 | 2.0 | 4.0 | 5.0 | 4.0 | 5.0 | 0.0 | 0.0 | 0.0 |
| Total | 100 | 100 | 100 | 100 | 100 | 100 | 100 | 100 | 100 |

The friction materials produced by the method described above were examined in a brake-dynamo/dual test (that is, a test where brakes for two wheels were fit to one axle and the power input was regulated to be identical for each brake or the total power input was regulated) in accordance with JASO C 407-87, under the following conditions. As shown in Table 2, the test conditions were as follows: the environmental temperature of the test brake was set at 273K, the initial brake lining temperature at 373K, the initial speed at 60 km/h, the final speed at 30 km/h, the deceleration at 1.5 m/s², and the number of braking was 100. Under the conditions described above, brake linings in Examples a to f and Comparative Examples A to C were attached to brake assemblies for the large-size truck front and measured by a brake dynamo tester.

TABLE 2

| Initial | | | | |
|---|---|---|---|---|
| speed | Final speed | Deceleration | Initial brake lining | Number of |
| km/h | km/h | m/s² | temperature K | braking |
| 60 | 30 | 1.5 | 373 | 100 |

The results of the dual test are as shown in Table 3, and in the Comparative Examples, Comparative Example A where lead sulfide had not been used was superior in judgment of burden on the environment but inferior in judgment of brake pull characteristics, and Comparative Examples B and C where lead sulfide had been used were superior in brake pull characteristics but poor in judgment of burden on the environment, while the Examples, as compared with Comparative Example A where lead sulfide had not been used, showed a significant reduction in brake pull to give good results, and in particular, Examples c, d and e were very good.

TABLE 3

| | | | | | | | Comparative | | |
|---|---|---|---|---|---|---|---|---|---|
| | Examples | | | | | | Examples | | |
| Items | a | b | c | d | e | f | A | B | C |
| Degree of brake pull | 19 | 13 | 2 | 3 | 3 | 9 | 41 | 16 | 4 |
| Judgment of brake pull | Δ | ◯ | ⊚ | ⊚ | ⊚ | ◯ | X | ◯ | ⊚ |
| characteristics | | | | | | | | | |
| Judgment of burden on the | ◯ | ◯ | ◯ | ◯ | ◯ | ◯ | ◯ | X | X |
| environment | | | | | | | | | |

Accordingly, the non-asbestos type friction material of the invention, when used particularly in brake linings for middle- to large-size commercial vehicles, is excellent not only in performance at the time of braking under high loading at high temperatures but also in performance at the time of braking under low loading at low temperatures, to achieve stable braking without generating environmental burden attributable to lead etc., as compared with the conventional friction materials using lead sulfide.

Industrial Applicability

This invention is as described above. Since lead sulfide used conventionally as the filler is not used while spherical bronze powder and artificial graphite are used, the friction material of the invention does not cause possible environmental burden attributable to lead sulfide and is thus suitable as a non-asbestos type friction material used in brake linings.

What is claimed is:

1. A non-asbestos type friction material comprising a non-asbestos fiber base material, a filler and a binder, wherein the filler comprises spherical bronze powder and artificial graphite and is free of lead sulfide.

2. The non-asbestos type friction material according to claim 1, wherein the content of the bronze powder is 0.1 to 3% by volume relative to the total amount the friction material.

3. The non-asbestos type friction material according to claim 1, wherein the content of the artificial graphite is 0.5 to 5% by volume relative to the total amount the friction material.

4. The non-asbestos type friction material according to claim 2, wherein the content of the artificial graphite is 0.5 to 5% by volume relative to the total amount the friction material.
